(19) United States
(12) Patent Application Publication
(10) Pub. No.: US 2016/0201596 A1
(43) Pub. Date: Jul. 14, 2016

(54) COMBUSTION CHAMBER STRUCTURE FOR ENGINE

(71) Applicant: Mazda Motor Corporation, Hiroshima (JP)

(72) Inventors: Takaaki Nagano, Higashihiroshima-shi (JP); Masahisa Yamakawa, Hiroshima-shi (JP); Takashi Youso, Hiroshima-shi (JP)

(21) Appl. No.: 14/979,329

(22) Filed: Dec. 22, 2015

(30) Foreign Application Priority Data
Jan. 9, 2015 (JP) 2015-003373

(51) Int. Cl. F02F 1/24

(52) U.S. Cl. CPC F02F 1/242; F02B 2275/14

(57) ABSTRACT

A combustion chamber structure for an engine, wherein the structure includes a piston formed with a downward dented cavity at a central part of an upper surface thereof, a fuel injector provided above the piston and in an extension line of a central axis of the piston, and for injecting fuel toward the cavity of the piston, and ignition plugs provided above the cavity and separated from the fuel injector in radial directions of the piston. A radius of the cavity, a depth of the cavity, and each of positions of the ignition plugs are designed so that a distance by which a mixture gas containing the fuel travels from a fuel injection start timing of the fuel injector to an ignition timing of the ignition plug becomes equal to or longer than a length of a path through which the injected fuel reaches each ignition plug via the cavity.

### BACKGROUND

The present invention relates to a combustion chamber structure for an engine, and particularly to a combustion chamber structure for an engine for injecting fuel in a latter half of a compression stroke and igniting the fuel after a top dead center of the compression stroke within a predetermined engine operating range.

Generally, for engines using gasoline or a fuel mainly including gasoline, a spark-ignition method in which ignition is performed by an ignition plug is broadly adopted. Recently, arts for performing compression self-ignition (specifically, premixed compression self-ignition referred to as HCCI (Homogeneous-Charge Compression Ignition)) within a predetermined engine operating range while using gasoline or fuel mainly including gasoline by applying a high compression ratio (e.g., 17:1 or higher) as a geometric compression ratio of the engine are developed in view of improving fuel consumption performance.

One art regarding an engine which performs such compression self-ignition is disclosed in JP2012-172662A, for example. In the art of JP2012-172662A, the engine performs the compression self-ignition within a low engine load range and performs spark ignition within a high engine load range, and within the high engine load range, the fuel is injected into a cavity of a piston of the engine and mixture gas containing the fuel is ignited at a timing at which the mixture gas travels to the vicinity of an ignition plug of the engine.

In such an engine, within the high engine load range (specifically, a range where the engine speed is low and the engine load is high), in view of suppressing pre-ignition (a phenomenon in which the mixture gas self-ignites before a normal combustion start timing triggered by spark ignition), smoke, etc., a target injection start timing is determined to be a timing in a latter half of a compression stroke and a target ignition timing is determined to be a timing after a top dead center of the compression stroke, according to an effective compression ratio, fuel pressure, etc. In this case, to start the fuel injection at the target injection start timing and surely start combusting the mixture gas at the target ignition timing, a distance by which the fuel travels from the target injection start timing to the target ignition timing (fuel spray traveling distance) is preferably at least equal to or longer than a length of a path through which the mixture gas containing the fuel injected by a fuel injector passes to reach the ignition plug (fuel spray traveling path length). In other words, a relationship “fuel spray traveling distance≧fuel spray traveling path length” is preferably established. Therefore, a configuration of the cavity of the piston, etc., may be designed to suitably achieve such a relationship.

### SUMMARY

The present invention is made in view of solving the issues of the conventional arts described above, and aims to provide a combustion chamber structure for an engine, in which a configuration of a cavity of a piston, etc., are suitably designed to surely start combustion of fuel at a predetermined ignition timing after the fuel is injected at a predetermined fuel injection start timing, and improve combustion stability.

According to one aspect of the present invention, a combustion chamber structure for an engine is provided. The engine injects fuel in a latter half of a compression stroke and ignites the fuel after a top dead center of the compression stroke within a predetermined engine operating range. The combustion chamber structure includes a piston formed with a downward dented cavity at a central part of an upper surface thereof, a fuel injector provided above the piston and in an extension line of a central axis of the piston, and for injecting the fuel toward the cavity of the piston, and at least one ignition plug provided above the cavity of the piston and separated from the fuel injector in radial directions of the piston. A radius of the cavity, a depth of the cavity, and each of positions of the at least one ignition plug are designed to have a fuel spray traveling distance that is equal to or longer than a fuel spray traveling path length, the fuel spray traveling distance being a distance by which mixture gas containing the fuel travels from a fuel injection start timing of the fuel injector to an ignition timing of each ignition plug, the fuel spray traveling path length being a length of a path through which the fuel injected by the fuel injector reaches each ignition plug via the cavity.

With this configuration, the radius of the cavity, the depth of the cavity, and the positions of the ignition plugs are designed to have the fuel spray traveling distance that is equal to or longer than the fuel spray traveling path length. Thus, the fuel injected at the predetermined fuel injection start timing can surely be made to start combusting at the predetermined ignition timing. As a result, the predetermined fuel injection start timing and the predetermined ignition timing can suitably be achieved while securing combustion stability.

The fuel spray traveling path length is preferably a total length of a first distance from a position where the fuel injector is provided, to a position of a surface of the cavity with which the fuel injected by the fuel injector at a predetermined injection angle collides, a second distance from the position of the surface of the cavity with which the fuel collides, to an outer edge portion of the cavity, and a third distance from the outer edge portion of the cavity to the position where each ignition plug is provided.

With this configuration, the fuel spray traveling path length defined suitably is used. Thus, the radius of the cavity, the depth of the cavity, and the positions of the ignition plugs can more accurately be designed to have the fuel spray traveling distance that is equal to or longer than the fuel spray traveling path length.

When the fuel spray traveling path length is “L1,” a cavity radius is “Rc,” a cavity depth is “Dc,” a distance between the fuel injector and each ignition plug is “Rs,” and the predetermined injection angle of the fuel from the fuel injector is “α,” the fuel spray traveling path length L1 is preferably expressed by the following Equation 1.

L1=Dc(1−sinα)/cosα+2Rc−Rs (1)

The fuel spray traveling distance is preferably determined based on a pressure of the fuel injected by the fuel injector, a predetermined target fuel injection start timing of the fuel injector, and a predetermined target ignition timing of each ignition plug.

With this configuration, the fuel spray traveling distance determined based on the target fuel injection start timing and the target ignition timing which are set to satisfy a predetermined condition is used. Thus, the fuel injected at the target fuel injection start timing can surely be made to start combusting at the target ignition timing while suitably satisfying such a predetermined condition.

When the fuel spray traveling distance is “L2,” the pressure of the fuel injected by the fuel injector is “P,” a time length from the target fuel injection start timing to the target ignition timing is “t,” and a predetermined coefficient is “k,” the fuel spray traveling distance L2 is preferably expressed by the following Equation 2.

L2=k×P^{0.5}×t² (2)

### BRIEF DESCRIPTION OF THE DRAWINGS

FIG. 1 is a schematic top view of a single cylinder in a cylinder axis direction, the single cylinder applied with a combustion chamber structure for an engine according to one embodiment of the present invention.

FIG. 2 is a top view of a piston in the cylinder axis direction according to the embodiment of the present invention.

FIG. 3 is a partial cross-sectional view of FIG. 1 including the piston and a cylinder head according to the embodiment of the present invention, taken along a line in FIG. 1.

FIG. 4 is a partial cross-sectional view of FIG. 1 including the piston and the cylinder head according to the embodiment of the present invention and taken similarly to FIG. 3, illustrating a fuel spray traveling path length according to the embodiment of the present invention.

FIG. 5 is a chart illustrating a specific example of a cavity diameter applied in the embodiment of the present invention.

### DETAILED DESCRIPTION OF EMBODIMENT

Hereinafter, a combustion chamber structure for an engine according to one embodiment of the present invention is described with reference to the appended drawings.

Before describing the contents of this embodiment of the present invention, a conditional configuration of an engine in this embodiment is briefly described. The engine of this embodiment is operated at a high compression ratio, for example, a geometric compression ratio is 14:1 or higher (suitably, between 17:1 and 18:1). Within a predetermined operating range of the engine (e.g., a range where an engine speed is low and an engine load is high), the engine injects fuel in a latter half of a compression stroke (retard injection) and ignites the fuel after a top dead center of the compression stroke (CTDC). Further, the engine of this embodiment performs a premixed compression self-ignition referred to as Homogeneous-Charge Compression Ignition (HCCI) within a predetermined low engine load range.

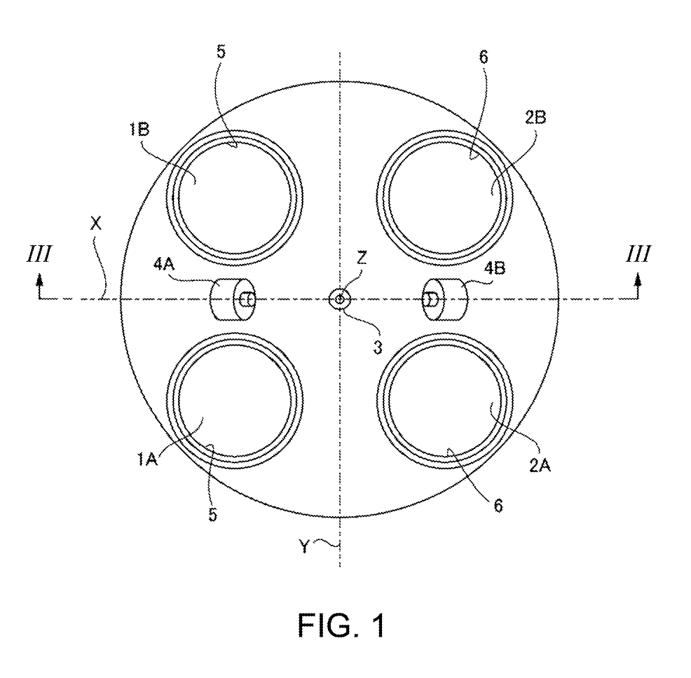

FIG. 1 is a schematic top view of a single cylinder in a cylinder axis direction, the single cylinder applied with a combustion chamber structure for an engine according to one embodiment of the present invention. In FIG. 1, the reference character “Z” indicates a cylinder axis extending in a direction perpendicular to the drawing sheet, and the reference character “Y” indicates a crankshaft axis extending in up-and-down directions of the drawing sheet. Further, the reference character “X” indicates a line segment passing the central axis of the cylinder and perpendicular to the crankshaft axis Y.

As illustrated in FIG. 1, the single cylinder is provided with two intake valves 1A and 1B at one side (left side in FIG. 1) section thereof with respect to the crankshaft axis Y. The two intake valves 1A and 1B are arranged in line along the crankshaft axis Y. The reference characters “5” in FIG. 1 indicate intake ports opened and closed by the two intake valves 1A and 1B. Hereinafter, when describing the two intake valves 1A and 1B without differentiating therebetween, each of the two intake valves 10A and 1B may simply be referred to as “the intake valve 1.”

Further, the single cylinder is provided with two exhaust valves 2A and 2B at the other side (right side in FIG. 1) section thereof with respect to the crankshaft axis Y. The two exhaust valves 2A and 2B are arranged in line along the crankshaft axis Y. The reference characters “6” in FIG. 1 indicate exhaust ports opened and closed by the two exhaust valves 2A and 2B. Hereinafter, when describing the two exhaust valves 2A and 2B without differentiating therebetween, each of the two exhaust valves 2A and 2B may simply be referred to as “the exhaust valve 2.”

Moreover, a single fuel injector 3 is disposed in an extension line of the cylinder axis Z. Additionally, a first ignition plug 4A is disposed between the intake valves 1A and 1B, and a second ignition plug 4B is disposed between the exhaust valves 2A and 2B. Hereinafter, when describing the two first and second ignition plugs 4A and 4B without differentiating therebetween, each of the two first and second ignition plugs 4A and 4B may simply be referred to as “the ignition plug 4.”

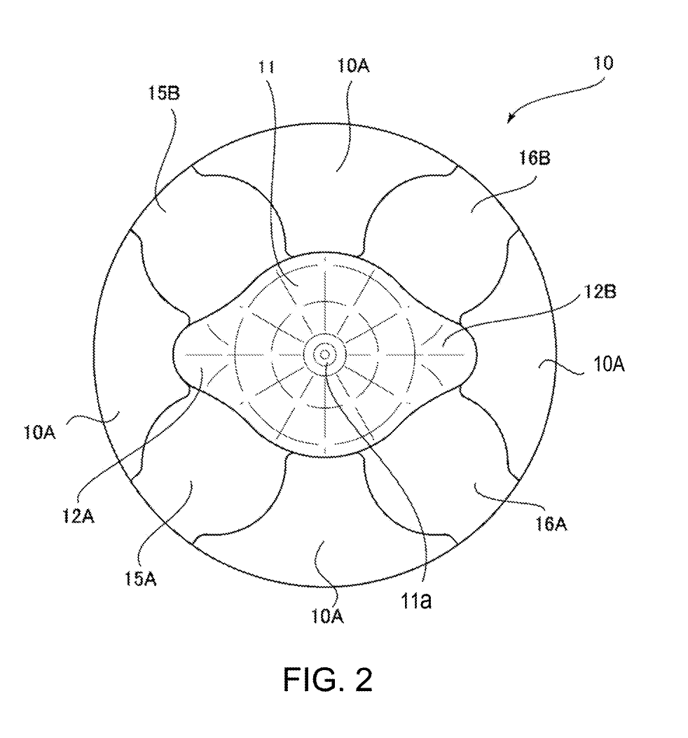

FIG. 2 is a top view of a piston 10 in the cylinder axis direction according to the embodiment of the present invention.

As illustrated in FIG. 2, a downward dented cavity 11 is formed at a central part of an upper surface (i.e., crown surface/top surface) of the piston 10. The cavity 11 has a circular shape when seen in the direction of the cylinder axis Z, and is formed with a bulge portion 11a at a central portion of the cavity 11. The cavity 11 is further formed with two concave portions 12A and 12B continuous from both end portions of the cavity 11, respectively. The fuel injector 3 is disposed immediately above the bulge portion 11a of the cavity 11, the first ignition plug 4A is disposed within the concave portion 12A of the cavity 11 when the piston is at the top dead center, and the second ignition plug 4B is disposed within the concave portion 12B of the cavity 11 when the piston is at the top dead center.

Moreover, the upper surface of the piston 10 is formed with four valve recesses 15A, 15B, 16A and 16B concaving downward by about 1 mm, for example. The valve recess 15A is formed at a position corresponding to the intake valve 1A, the valve recess 15B is formed at a position corresponding to the intake valve 1B, the valve recess 16A is formed at a position corresponding to the exhaust valve 2A, and the valve recess 16B is formed at a position corresponding to the exhaust valve 2B. Further, the upper surface of the piston 10, except for the cavity 11 and the valve recesses 15A, 15B, 16A and 16B, is substantially flat in directions perpendicular to the cylinder axis Z. In FIG. 2, each of the flat portions is denoted with the reference character “10A” (hereinafter, each flat portion is suitably described as “the piston upper surface portion 10A”).

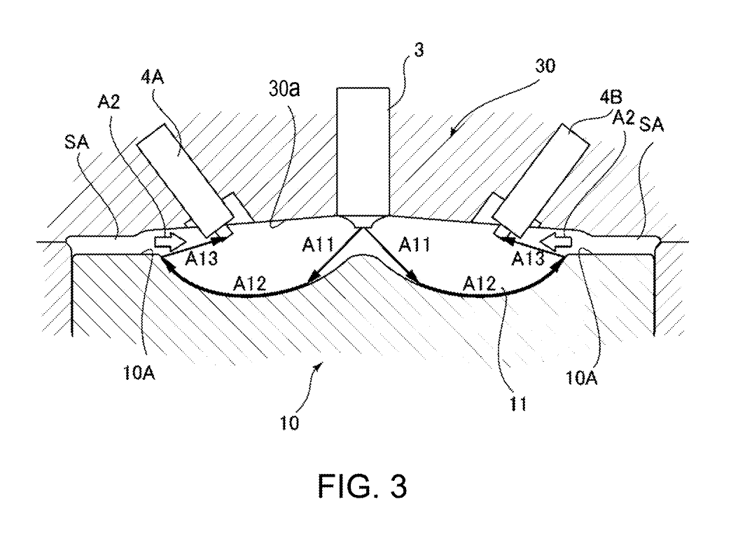

FIG. 3 is a partial cross-sectional view of FIG. 1 including the piston 10 and a cylinder head 30 according to the embodiment, taken along a line in FIG. 1. Note that FIG. 3 illustrates a state when the piston 10 is at the CTDC. Further, regarding the fuel injector 3 and the ignition plugs 4, FIG. 3 illustrates side views instead of cross-sectional views.

In this embodiment, as indicated by the arrows All of FIG. 3, the fuel is injected from the fuel injector 3 toward the cavity 11, in other words, into the cavity 11. In this manner, mixture gas containing the fuel injected toward the cavity 11, as indicated by the arrows A12, collides with the surface of the cavity 11, flows outward in radial directions of the cavity 11 while following the surface (specifically, curving surface) of the cavity 11, and reaches an outer edge portion of the cavity 11. Then, the mixture gas at the outer edge portion of the cavity 11 receives influence of squish flows (see the white arrows A2) causing the gas to flow radially inward from squish areas SA, and influence of negative pressure caused below the fuel injector 3 by the fuel injection, each of the squish areas SA formed in a gap between each piston upper portion 10A and a bottom surface 30a of the cylinder head 30. Thus, the mixture gas flows toward the ignition plugs 4 as indicated by the arrows A13. By igniting the fuel with the ignition plugs 4 at the timing of the mixture gas reaching the ignition plugs 4 as above, the mixture gas can surely be made to start to combust.

Here, in this embodiment, in view of suppressing pre-ignition, smoke, etc., a predetermined timing in the latter half of the compression stroke is applied as a target injection start timing and a predetermined timing after the CTDC is applied as a target ignition timing, according to an effective compression ratio, fuel pressure, etc. Further, a configuration is adopted so that after the fuel injection is started at the target injection start timing, the fuel can surely be ignited (start to combust) by the ignition plugs 4 at the target ignition timing.

Specifically, in this embodiment, a distance by which the mixture gas containing the fuel travels from the target fuel injection start timing to the target ignition timing (fuel spray traveling distance) is designed to be equal to or longer than a total length of paths indicated by the arrows All, A12 and A13 in FIG. 3, through which the mixture gas containing the fuel injected by the fuel injector 3 passes to reach the ignition plugs 4 (fuel spray traveling path length). More specifically, in this embodiment, parameters defining the fuel spray traveling path length, including a radius of the cavity 11, a depth of the cavity 11, and positions of the ignition plugs 4, are designed so that the fuel spray traveling distance becomes equal to or longer than the fuel spray traveling path length.

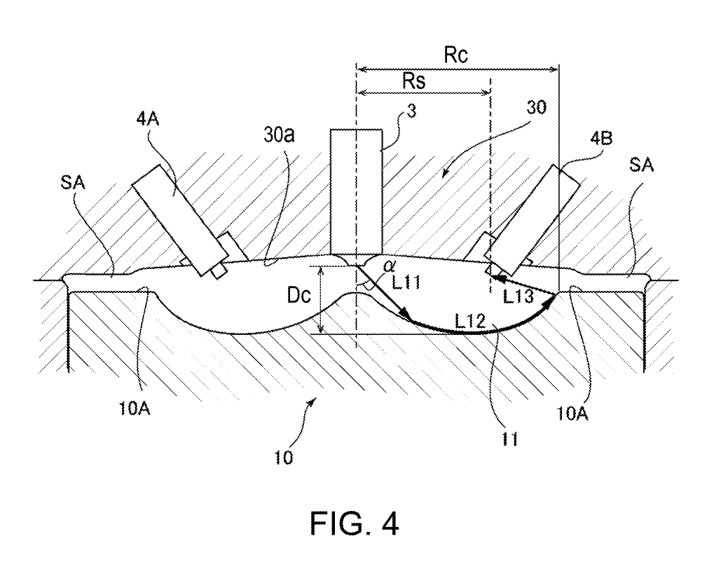

Next, the fuel spray traveling path length of this embodiment is described in detail with reference to FIG. 4. FIG. 4 is a view taken similar to FIG. 3 and, for the sake of convenience, only the path for the mixture gas containing the fuel injected by the fuel injector 3 to reach one of the ignition plugs 4 provided on the right side (second ignition plug 4B) is illustrated.

In FIG. 4, the reference character “Rc” indicates the cavity radius, the reference character “Rs” indicates a distance between the fuel injector 3 and the ignition plug 4 in the radius direction, the reference character “Dc” indicates the cavity depth corresponding to a distance between the fuel injector 3 and a deepest portion of the cavity 11 in the cylinder axis direction when the piston 10 is at the top dead center (compression top dead center), and the reference character “α” indicates an injection angle of the fuel from the fuel injector 3 defined based on the cylinder axis (i.e., a central axis of the fuel injector 3).

Further in FIG. 4, the reference character “L11” indicates a distance from a position where the fuel injector 3 is provided, to a position of the surface of the cavity 11 with which the fuel injected by the fuel injector 3 at the injection angle a collides, in other words, the reference character “L11” corresponds to the length of the path indicated by the arrow A11 in FIG. 3. The distance L11 can be expressed by the following Equation 3 by using the cavity depth Dc and the injection angle α.

L11=Dc/cosα (3)

Moreover in FIG. 4, the reference character “L12” indicates a distance from the position of the surface of the cavity 11 with which the fuel injected by the fuel injector 3 collides, to the outer edge portion of the cavity 11, in other words, the reference character “L12” corresponds to the length of the path indicated by the arrow A12 in FIG. 3. The distance L12 can be expressed by the following Equation 4 by using the cavity radius Rc, the cavity depth Dc, and the injection angle α.

L12=Rc−Dc×sinα/cosα (4)

Furthermore in FIG. 4, the reference character “L13” indicates a distance from the outer edge portion of the cavity 11 to a position where the ignition plug 4 is provided, in other words, the reference character “L13” corresponds to the length of the path indicated by the arrow A13 in FIG. 3. The distance L13 can be expressed by the following Equation 5 by using the cavity radius Rc and the distance Rs between the fuel injector 3 and the ignition plug 4.

L13=Rc−Rs (5)

Here, when the fuel spray traveling path length is “L1,” the fuel spray traveling path length L1 is expressed by using L11, L12, and L13 described above, as “L1=L11+L12+L13.” Therefore, by substituting the above Equations 3 to 5 into this equation, the fuel spray traveling path length L1 can be expressed by the following Equation 6.

L1=Dc(1−sinα)/cosα+2Rc−Rs (6)

On the other hand, when the fuel spray traveling distance is “L2,” the pressure of the fuel injected by the fuel injector 3 is “P,” the time length from the target fuel injection start timing to the target ignition timing described above is “t,” and a predetermined coefficient is “k,” the fuel spray traveling distance L2 can be expressed by the following Equation 7.

L2=k×P^{0.5}×t² (7)

Note that for the target fuel injection start timing, a timing in the latter half of the compression stroke, for example, a timing corresponding to “−9°,” is applied as a fuel injection start timing capable of suitably suppressing pre-ignition when the high compression ratio is applied. Further, for the target ignition timing, a timing immediately after the compression stroke (i.e., an early half of expansion stroke), for example, a timing corresponding to “3°,” is applied as an ignition timing that is close to an ignition timing with which a highest engine torque is obtained (Minimum advance for the Best Torque (MBT)), and capable of suitably suppressing smoke (knocking may be included). With these example timings, when the engine speed is 2,000 rpm, the time length t from the target fuel injection start timing to the target ignition timing becomes “t(sec)=){(3°+9°)/360°}/(2000/60).”

Moreover, as the fuel pressure P, a comparatively high fuel pressure may be applied so that the time length from the fuel injection start timing to the ignition timing can be shortened (i.e., the fuel injection start timing can be retarded and a response period of time from the retarded fuel injection start timing to the ignition can be shortened) so as to suppress abnormal combustion (e.g., pre-ignition). For example, a highest fuel pressure may be applied. In one example, “120 MPa” is applied as the fuel pressure P.

Further, the predetermined coefficient k is applied as a value obtained in advance based on experiment(s), predetermined equation(s), etc.

To summarize, in this embodiment, the cavity radius Rc, the distance Rs between the fuel injector 3 and each ignition plug 4, and the cavity depth Dc are designed based on the following Equation 8 applying the above Equations 6 and 7, so that the fuel spray traveling distance L2 becomes equal to or longer than the fuel spray traveling path length L1, in other words, the condition “L2>L1” is satisfied.

k×P^{0.5}×t²≧Dc(1−sinα)/cosα+2Rc−Rs (8)

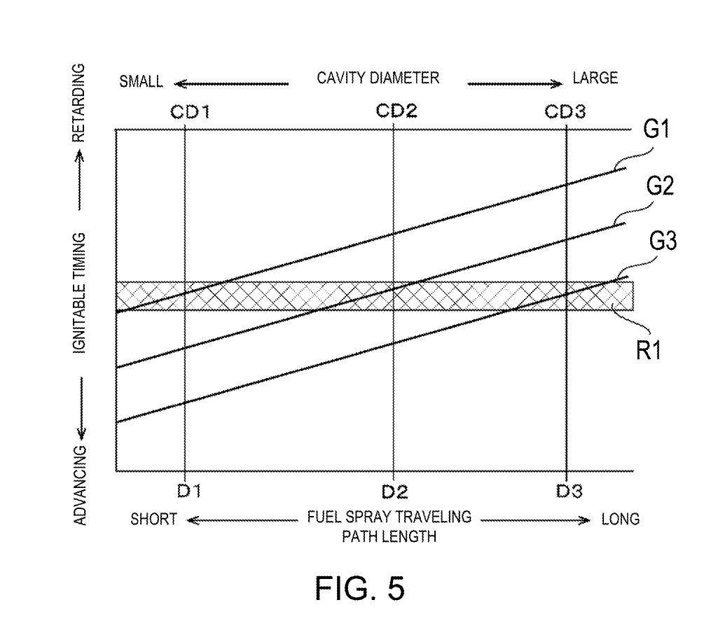

Next, a specific example of the cavity radius (and therefore cavity diameter) applied in this embodiment is described with reference to FIG. 5. In FIG. 5, the horizontal axis indicates the fuel spray traveling path length (the cavity diameter constituting the fuel spray traveling path length is also correspondingly indicated thereabove), and the vertical axis indicates an ignitable timing. The ignitable timing is defined under a condition that the fuel is injected at a predetermined fuel injection start timing (e.g., the timing corresponding to “−9°”) while the engine is operated at a high engine load and a low engine speed (e.g., the full load is 2,000 rpm). The ignitable timing corresponds to a timing at which combustion of the mixture gas containing the fuel can suitably be made to start to combust by the ignition plugs 4, in other words, a timing at which the mixture gas containing the fuel reaches the positions where the ignition plugs 4 are provided.

In FIG. 5, the graph G1 indicates a relationship between the fuel spray traveling path length and the ignitable timing when a comparatively low fuel pressure (e.g., 60 MPa) is used, the graph G2 indicates a relationship between the fuel spray traveling path length and the ignitable timing when a fuel pressure higher than that of the graph G1 (e.g., 80 MPa) is used, and the graph G3 indicates a relationship between the fuel spray traveling path length and the ignitable timing when a fuel pressure higher than that of the graph G2 (e.g., 120 MPa) is used.

Based on the graphs G1 to G3, it can be understood that the ignitable timing is retarded as the fuel spray traveling path length becomes longer. In other words, it can be understood that the fuel spray traveling path length needs to be shortened to advance the ignitable timing. Moreover, based on the graphs G1 to G3, it can be understood that the ignitable timing is advanced as the fuel pressure becomes higher.

Here, a case where an ignition timing within a range indicated by the reference character “R1” (e.g., approximately between 2° to 4°) is applied as the target ignition timing is considered. When the fuel pressure indicated by the graph G1 (e.g., 60 MPa) is used, to suitably start combusting the mixture gas by the ignition plugs 4 within the target ignition timing range R1, a fuel spray traveling path length D1 (e.g., about 37 mm) may be applied. In this case, a cavity diameter CD1 (e.g., about 50 mm) corresponding to the fuel spray traveling path length D1 may be applied. When the fuel pressure indicated by the graph G2 (e.g., 80 MPa) is used, to suitably start combusting the mixture gas by the ignition plugs 4 within the target ignition timing range R1, a fuel spray traveling path length D2 (e.g., about 40 mm) may be applied. In this case, a cavity diameter CD2 (e.g., about 54 mm) corresponding to the fuel spray traveling path length D2 may be applied. When the fuel pressure indicated by the graph G3 (e.g., 120 MPa) is used, to suitably start combusting the mixture gas by the ignition plugs 4 within the target ignition timing range R1, a fuel spray traveling path length D3 (e.g., about 42 mm) may be applied. In this case, a cavity diameter CD3 (e.g., about 58 mm) corresponding to the fuel spray traveling path length D3 may be applied.

Note that within the engine operating range where the engine speed is low and the engine load is high, a comparatively high fuel pressure is preferably applied so that the time length from the fuel injection start timing to the ignition timing can be shortened (i.e., the fuel injection start timing can be retarded and the response time period from the retarded fuel injection start timing to the ignition can be shortened), so as to suppress the abnormal combustion (e.g., pre-ignition). Therefore, in the example of FIG. 5, the fuel pressure indicated by the graph G3 (e.g., 120 MPa) is preferably applied. Further, when this fuel pressure is applied, the cavity diameter CD3 (e.g., about 58 mm) may be applied.

Next, the operations and effects of the combustion chamber structure for the engine according to this embodiment of the present invention are described. According to this embodiment, the cavity diameter, the cavity depth, and the positions of the ignition plugs 4 are designed so that the fuel spray traveling distance (the distance by which the mixture gas containing the fuel travels from the target fuel injection start timing to the target ignition timing) becomes equal to or longer than the fuel spray traveling path length (the length of the path through which the mixture gas containing the fuel injected by the fuel injector 3 reaches each ignition plug 4 via the cavity 11). Thus, the fuel injected at the target fuel injection start timing can surely be made to start combusting at the target ignition timing. As a result, the target fuel injection start timing and the target ignition timing can suitably be achieved while securing combustion stability.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### LIST OF REFERENCE CHARACTERS

1A, 1B Intake Valve
2A, 2B Exhaust Valve
3 Fuel Injector
4A First Ignition Plug
4B Second Ignition Plug
10 Piston
11 Cavity
30 Cylinder Head

What is claimed is:

1. A combustion chamber structure for an engine, the engine injecting fuel in a latter half of a compression stroke and igniting the fuel after a top dead center of the compression stroke within a predetermined engine operating range, the combustion chamber structure comprising:
a piston formed with a downward dented cavity at a central part of an upper surface thereof;
a fuel injector provided above the piston and in an extension line of a central axis of the piston, and for injecting the fuel toward the cavity of the piston; and
at least one ignition plug provided above the cavity of the piston and separated from the fuel injector in radial directions of the piston,
wherein a radius of the cavity, a depth of the cavity, and each of positions of the at least one ignition plug are designed to have a fuel spray traveling distance that is equal to or longer than a fuel spray traveling path length, the fuel spray traveling distance being a distance by which mixture gas containing the fuel travels from a fuel injection start timing of the fuel injector to an ignition timing of each ignition plug, the fuel spray traveling path length being a length of a path through which the fuel injected by the fuel injector reaches each ignition plug via the cavity.

2. The structure of claim 1, wherein the fuel spray traveling path length is a total length of a first distance from a position where the fuel injector is provided, to a position of a surface of the cavity with which the fuel injected by the fuel injector at a predetermined injection angle collides, a second distance from the position of the surface of the cavity with which the fuel collides, to an outer edge portion of the cavity, and a third distance from the outer edge portion of the cavity to the position where each ignition plug is provided.

3. The structure of claim 2, wherein when the fuel spray traveling path length is “L1,” a cavity radius is “Rc,” a cavity depth is “Dc,” a distance between the fuel injector and each ignition plug is “Rs,” and the predetermined injection angle of the fuel from the fuel injector is “α,” the fuel spray traveling path length L1 is expressed by the following Equation 1.
L1=Dc(1−sinα)/cosα+2Rc−Rs (1)

4. The structure of claim 1, wherein the fuel spray traveling distance is determined based on a pressure of the fuel injected by the fuel injector, a predetermined target fuel injection start timing of the fuel injector, and a predetermined target ignition timing of each ignition plug.

5. The structure of claim 4, wherein when the fuel spray traveling distance is “L2,” the pressure of the fuel injected by the fuel injector is “P,” a time length from the target fuel injection start timing to the target ignition timing is “t,” and a predetermined coefficient is “k,” the fuel spray traveling distance L2 is expressed by the following Equation 2.
L2=k×P^{0.5}×t² (2)

6. A combustion chamber structure for an engine, the engine injecting fuel in a latter half of a compression stroke and igniting the fuel after a top dead center of the compression stroke within a predetermined engine operating range, the combustion chamber structure comprising:
a piston formed with a downward dented cavity at a central part of an upper surface thereof;
a fuel injector provided above the piston and in an extension line of a central axis of the piston, and for injecting the fuel toward the cavity of the piston; and
at least one ignition plug provided above the cavity of the piston and separated from the fuel injector in radial directions of the piston,
wherein when a fuel spray traveling distance is “L2” and a fuel spray traveling path length is “L1,” a radius of the cavity, a depth of the cavity, and each of positions of the at least one ignition plug are designed based on Equation 8 below to satisfy “L2>L1,” the fuel spray traveling distance being a distance by which a mixture gas containing the fuel travels from a fuel injection start timing of the fuel injector to an ignition timing of each ignition plug, the fuel spray traveling path length being a length of a path through which the fuel injected by the fuel injector reaches each ignition plug via the cavity.
k×P^{0.5}×t²>Dc(1−sinα)/cosα+2Rc−Rs (8)
